(19) United States
(12) Patent Application Publication
(10) Pub. No.: US 2024/0248450 A1
(43) Pub. Date: Jul. 25, 2024

(54) INFORMATION PROCESSING DEVICE, INFORMATION PROCESSING METHOD, AND RECORDING MEDIUM RECORDED WITH INFORMATION PROCESSING PROGRAM

(71) Applicant: TOYOTA JIDOSHA KABUSHIKI KAISHA, Toyota-shi (JP)

(72) Inventors: Tetsuya SHOJI, Susono-shi (JP); Masao YANO, Sunto-gun (JP); Hanae SHIRATORI, Susono-shi (JP)

(73) Assignee: TOYOTA JIDOSHA KABUSHIKI KAISHA, Toyota-shi (JP)

(21) Appl. No.: 18/413,951

(22) Filed: Jan. 16, 2024

(30) Foreign Application Priority Data
Jan. 25, 2023 (JP) 2023-009702

(51) Int. Cl. G05B 19/048

(52) U.S. Cl. CPC G05B 19/048; G05B 2219/25064

(57) ABSTRACT

An information processing device that acquires a data set including a combination of state data representing a time series of states when a target object is worked combined with at least one of performance data representing a performance of the target object, data representing a structure or physical property of the target object, or process data representing a process setting value when the target object is worked. The information processing device generates a principal component value of each of a plurality of items of the state data in the acquired data set by executing principal component analysis on the plurality of items of state data. The information processing device outputs information representing a relationship between principal component values of the plurality of items of state data, and the at least one of the performance data, the data representing the structure or physical property, or the process data.

### CROSS-REFERENCE TO RELATED APPLICATION

This application is based on and claims priority under 35 USC 119 from Japanese Patent Application No. 2023-009702 filed on Jan. 25, 2023, the disclosure of which is incorporated by reference herein.

### BACKGROUND

### Technical Field

The present disclosure relates to an information processing device, an information processing method, and a recording medium recorded with an information processing program.

### Related Art

A temperature profile setting system for setting a temperature profile for heat treatment of a metal workpiece is disclosed in Japanese Patent Application Laid-Open (JP-A) No. 2021-025110. This temperature profile setting system acquires a type, quality of material, and shape parameter of a workpiece to be subjected to processing. This information is obtained by machine learning or the like based on captured image data of the workpiece. The temperature profile setting system also performs machine learning based on a temperature profile database stored with temperature profiles and the like that have been applied in past heat treatment, generates a learning model for setting a temperature profile for heat treatment according to a shape parameter for each type and quality of material of workpiece, and sets the temperature profile using the learning model. Furthermore, the temperature profile setting system uses an image on a display to display a prescribed setting state for the target workpiece.

However, sometimes a user wants to know a relationship between a performance (for example a mechanical strength or the like) of a given target object and data representing a state when the target object is worked (for example, the “temperature profile” disclosed in JP-A No. 2021-025110). Moreover similarly, sometimes a user wants to know a relationship between data representing the state when the target object is worked and setting values of a work process when the target object is worked. Moreover similarly, sometimes a user wants to know a relationship between data representing the state when the target object is worked and a structure or physical property of the target object.

In the temperature profile setting system disclosed in JP-A No. 2021-025110, a temperature profile is set for heat treatment of the metal workpiece. However, the technology disclosed in JP-A No. 2021-025110 is not technology for outputting a relationship between a performance of the metal workpiece that is the target object, a structure or physical property of the metal workpiece, or a setting value of the processing processes of the metal workpiece, and the temperature profile that is data representing a state when the target object is worked.

An object of the present disclosure is to provide an information processing device, an information processing method, and an information processing program that are capable of acquiring information representing a relationship between time series data of a state when a target object is worked, and a performance of the target object, a structure or physical property of the target object, or a process setting value when the target object is worked.

### SUMMARY

An information processing device according to a first aspect is an information processing device including an acquisition section, an analysis section, and an output section. The acquisition section acquires a data set including a combination of state data representing a time series of states when a target object is worked combined with at least one of performance data representing a performance of the target object, data representing a structure or physical property of the target object, or process data representing a process setting value when the target object is worked. The analysis section generates a principal component value of each of plural items of the state data in the data set acquired by the acquisition section by executing principal component analysis on the plural items of state data. The output section outputs information representing a relationship between the generated principal component values of the plural items of state data, and the at least one of the performance data, the data representing the structure or physical property, or the process data. The information processing device according to the first aspect enables information to be acquired that represents a relationship between time series data of states when a target object is worked, and performance of the target object, a structure or physical property of the target object, or a process setting value when the target object is worked.

The output section of an information processing device according to a second aspect outputs data representing a two-dimensional map including plot points of the principal component values of the state data as the information representing the relationship, and changes a color of the plot points representing the principal component values according to at least one of a value expressed in the performance data, a value expressed in the data representing the structure or physical property, or a value expressed in the process data. The information processing device according to the second aspect changes the color of the plot points representing the principal component values according to the at least one of the value expressed in the performance data, the value expressed in the data representing the structure or physical property of the target object, or the value expressed in the process data, and so this enables a user to visually ascertain a relationship between the principal component value and the value expressed in the performance data, the value expressed in the data representing the structure or physical property of the target object, or the value expressed in the process data.

The output section of an information processing device according to a third aspect outputs, as the information representing the relationship, information representing a correlation between the principal component values and at least one of a value expressed in the performance data, a value expressed in the data representing the structure or physical property, or a value expressed in the process data. The information processing device according to the third aspect enables a user to obtain a correlation between the principal component value and the value expressed in the performance data, the value expressed in the data representing the structure or physical property of the target object, or the value expressed in the process data.

The output section of an information processing device according to a fourth aspect outputs, as the information representing the relationship, information representing a regression equation between the principal component values and at least one of a value expressed in the performance data, a value expressed in the data representing the structure or physical property, or a value expressed in the process data. The information processing device according to the fourth aspect enables a user to obtain a regression equation between the principal component value and a value expressed in the performance data, a value expressed in the data representing the structure or physical property of the target object, or a value expressed in the process data.

The output section of an information processing device according to a fifth aspect identifies unknown data representing a plot point different from already existing plot points on the two-dimensional map, and transforms the unknown data into the state data. The information processing device according to the fifth aspect enables a user to obtain state data corresponding to the unknown data. Note that the transformation processing from the unknown data to the state data may utilize a machine learning model. In such cases, for example, state data is output from a trained model trained in advance by machine learning with training data by inputting the unknown data into the trained model.

An information processing method according to a sixth aspect is an information processing method of processing executed by a computer. The processing includes: acquiring a data set including a combination of state data representing a time series of states when a target object is worked combined with at least one of performance data representing a performance of the target object, data representing a structure or physical property of the target object, or process data representing a process setting value when the target object is worked: generating a principal component value of each of plural items of the state data in the acquired data set by executing principal component analysis on the plural items of state data; and outputting information representing a relationship between principal component values of the plural items of state data, and the at least one of the performance data, the data representing the structure or physical property, or the process data. The information processing method according to the sixth aspect enables information to be acquired that represents the relationship between time series data of states when a target object is worked, and the performance of the target object, the structure or physical property of the target object, or the process setting value when the target object is worked.

A recording medium recorded with an information processing program according to a seventh aspect is a recording medium recorded with an information processing program that causes a computer to execute processing. The processing includes: acquiring a data set including a combination of state data representing a time series of states when a target object is worked combined with at least one of performance data representing a performance of the target object, data representing a structure or physical property of the target object, or process data representing a process setting value when the target object is worked: generating a principal component value of each of plural items of the state data in the acquired data set by executing principal component analysis on the plural items of state data: and outputting information representing a relationship between principal component values of the plural items of state data, and the at least one of the performance data, the data representing the structure or physical property, or the process data. The recording medium recorded with the information processing program according to the seventh aspect enables information to be acquired that represents a relationship between time series data of states when a target object is worked, and performance of the target object, a structure or physical property of the target object, or a process setting value when the target object is worked.

The present disclosure as described above exhibits the advantageous effect of enabling information to be acquired that represents a relationship between time series data of states when a target object is worked, and performance of the target object, a structure or physical property of the target object, or a process setting value when the target object is worked.

### BRIEF DESCRIPTION OF THE DRAWINGS

Exemplary embodiments of the present disclosure will be described in detail based on the following figures, wherein:

FIG. 1 is a block diagram illustrating an example of a functional configuration of an information processing system 10 according to an exemplary embodiment:

FIG. 2 is a diagram illustrating an example of a data set:

FIG. 3 is a diagram to explain vectorization of state data:

FIG. 4 is a diagram illustrating an example of associated principal component values in a data set:

FIG. 5 is a diagram illustrating an example of information representing relationships between principal component values for plural items of state data and performance values or process setting values:

FIG. 6 is a diagram illustrating an example of information representing correlations between principal component values of plural items of state data and performance data or process data:

FIG. 7 is a diagram to explain transformation from unknown data to state data:

FIG. 8 is a diagram illustrating an example of a configuration of a computer of a server and a user terminal according to an exemplary embodiment; and

FIG. 9 is a flowchart illustrating an example of processing performed by the server according to an exemplary embodiment.

### DETAILED DESCRIPTION

Explanation follows regarding an information processing system of an exemplary embodiment, with reference to the drawings.

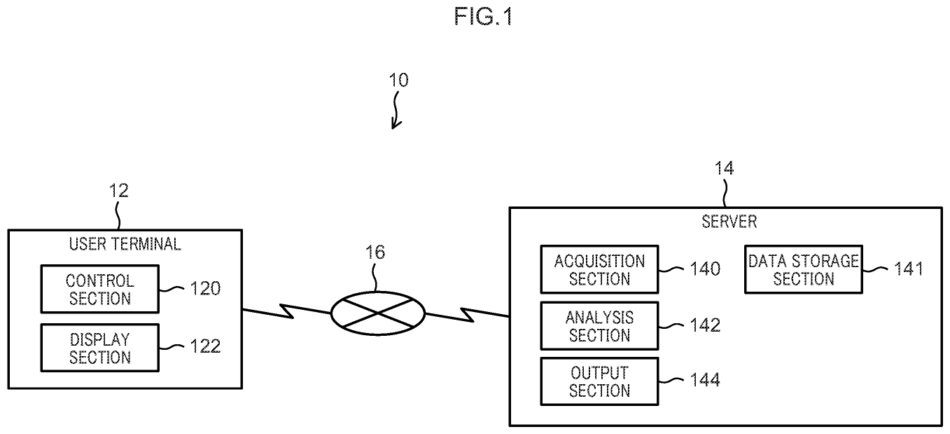

FIG. 1 is a block diagram illustrating an example of a functional configuration of an information processing system 10 according to an exemplary embodiment. As illustrated in FIG. 1, the information processing system 10 includes a user terminal 12, and a server 14 serving as an example of an information processing device. The user terminal 12 and the server 14 are, for example, connected so as to be capable of communicating with each other over a network 16 such as the internet.

The information processing system 10 of the present exemplary embodiment executes principal component analysis on state data representing a time series of states when a given target object is worked, so as to output information representing a relationship between the state data and performance of the target object or process setting values when the target object is worked. More specific description follows. Note that target object refers, for example, to a material or the like that is a target for analysis.

### User Terminal

The user terminal 12 is operated by a user. The user terminal 12 includes, from a functional perspective, a control section 120 and a display section 122, as illustrated in FIG. 1.

The control section 120 controls operation of the user terminal 12. The display section 122 displays various information under control by the control section 120.

### Server

The server 14 includes, from a functional perspective, an acquisition section 140, a data storage section 141, an analysis section 142, and an output section 144, as illustrated in FIG. 1.

The acquisition section 140 acquires a data set transmitted from the user terminal 12 representing combinations of state data, target object performance data, and process data. The acquisition section 140 stores the data set in the data storage section 141.

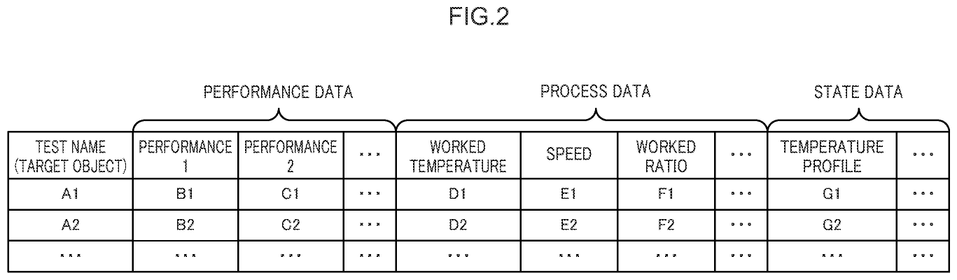

The data set is stored in the data storage section 141. FIG. 2 is a diagram illustrating an example of a data set. As illustrated in FIG. 2, for example, one item of data in the data set is stored with performance data, process data, and state data, stored associated with each other. The performance data is data representing a performance of the target object. The target object performance expressed in the performance data is, for example, a mechanical strength, a surface reflectivity, or a transmissivity of the target object. The process data is data representing a process setting value when the target object is worked. The process setting value expressed in the process data is, for example, a working temperature, a working speed, or a working ratio or the like when working the target object. The state data is data representing a time series of states when the target object is worked and is, for example, data of a temperature profile when the target object is worked. The temperature profile is, for example, temperatures of the target object while the target object is being worked, or a temperature profile at a specific location in an apparatus for working the target object.

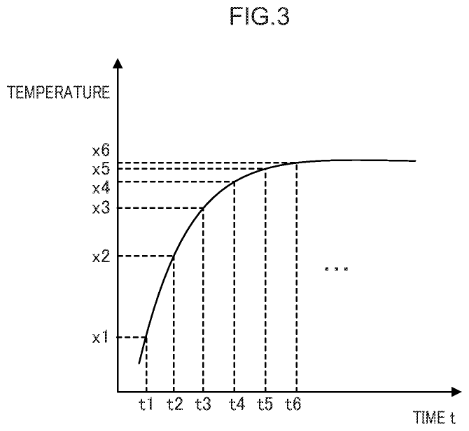

FIG. 3 is a diagram to explain vectorization of the state data. In cases in which a temperature profile such as illustrated in FIG. 3 is the state data, vectors are generated with temperatures x1 to x6 of respective times t1 to t6 or the like as each component. Then, as described later, principal component analysis is executed on these vectors.

The analysis section 142 reads the data set from the data storage section 141, and generates principal component values of plural items of state data by executing principal component analysis on the plural items of state data in the data set.

More specifically, first the analysis section 142 executes pre-processing on the plural items of state data in the data set. Sometimes there is numerical data in a range not needed for analysis included in the plural items of state data. Moreover, the plural items of state data include cases in which the start point is different, cases in which the data length is different, and the like.

The analysis section 142 accordingly executes specific threshold processing or the like on each of the respective plural items of state data in the data set to remove numerical data in a range not needed for analysis. The analysis section 142 also executes pre-processing so as to align start points and data lengths across the plural items of state data in the data set.

Next, the analysis section 142 transforms each of the state data that has been subjected to pre-processing into vector data. The analysis section 142 generates principal component values for each of the plural items of state data by executing principal component analysis on the vector data corresponding to the plural items of state data. The analysis section 142 stores the principal component value for each of the plural items of state data in the data storage section 141.

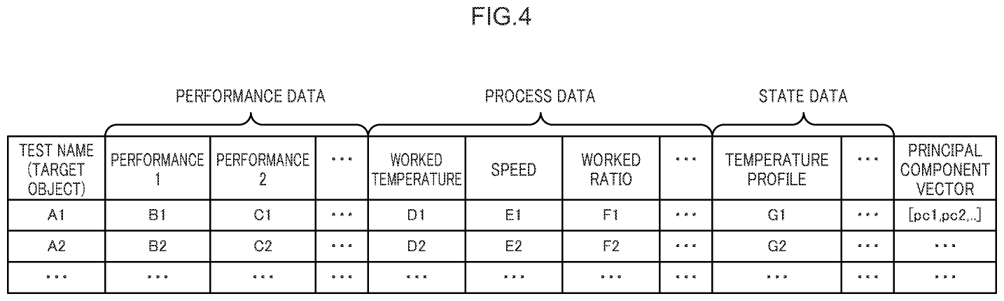

FIG. 4 is a diagram illustrating an example of principal component values stored in the data storage section 141. As illustrated in FIG. 4, a single principal component vector (more specifically a vector containing a principal component value for each component) is stored in the data storage section 141 associated with each single item of data.

By referencing data such as that illustrated in FIG. 4, the output section 144 outputs information representing a relationship between principal component values of plural items of state data generated by the analysis section 142 and performance values expressed in the performance data or process setting values expressed in the process data.

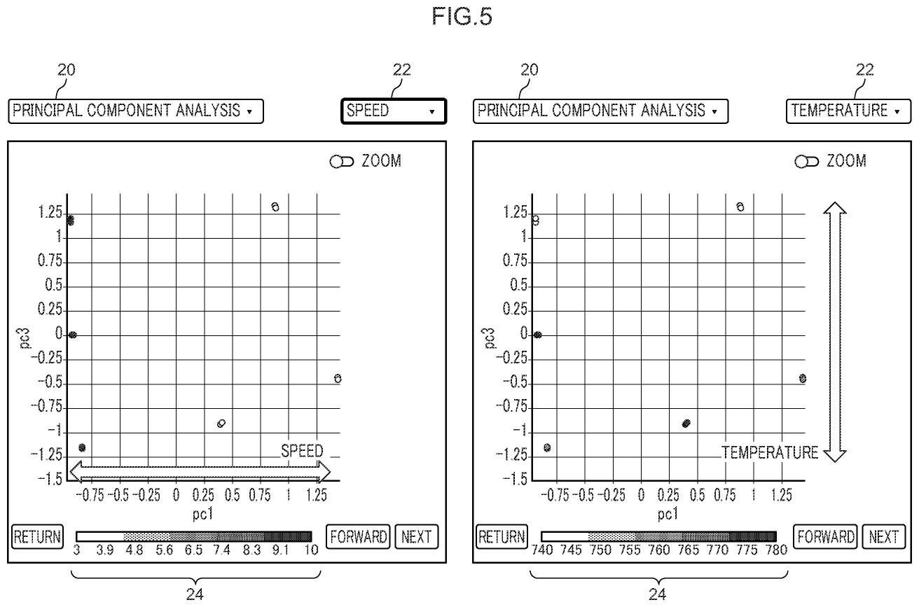

FIG. 5 is a diagram illustrating an example of information representing a relationship between principal component values of plural items of state data and performance values or process setting values. A single plot point illustrated in FIG. 5 corresponds to principal component values of a single item of state data.

Tab 20 illustrated in FIG. 5 is a tab for a user to select an analysis technique, and principal component analysis is selected in the example of FIG. 5. Tab 22 illustrated in FIG. 5 is a tab for a user to select a type of performance value or a type of process setting value. A transition is made to a different screen when the “return”, “forward”, or “next” buttons of FIG. 5 are pressed.

The tab 22 shows “speed” in the diagram on the left side of FIG. 5, and relationships between principal component values of plural items of state data and working speed that is a process setting value are illustrated. A horizontal bar 24 in the diagram on the left side of FIG. 5 represents a magnitude of working speed, with darker colors inside the horizontal bar 24 representing faster working speeds. Reference to the two-dimensional map on the left side of FIG. 5 indicates that the smaller values of pc1 are for faster working speeds and the larger the values of pc1 are for slower working speeds. It is accordingly apparent that the values of the principal component values pc1 obtained as a result of principal component analysis are related to working speed.

Moreover, the tab 22 shows “temperature” in the diagram on the right of FIG. 5, and a relationships between principal component values of plural items of state data and working temperature that is a process setting value are illustrated. The horizontal bar 24 in the diagram on the right of FIG. 5 represents a magnitude of working temperature, with darker colors inside the horizontal bar 24 indicating higher working temperatures. Reference to the two-dimensional map on the right side of FIG. 5 indicates that the smaller values of pc3 tend to be for high working temperatures, and that the larger values of pc3 tend to be for low working temperatures. It is accordingly apparent that the values of the principal component values pc3 obtained as a result of principal component analysis are related to working temperature.

The output section 144 transmits information such as illustrated in FIG. 5 to the user terminal 12.

The user terminal 12 receives the information transmitted from the server 14 and displays this information on its own display section 122.

A user operating the user terminal 12 checks the two-dimensional map output from the server 14, and checks a relationship between the principal component values of plural items of state data and performance values expressed in the performance data or process setting values expressed in the process data. The user inputs operation information to change the tab 22 on the two-dimensional map to the user terminal 12 by operating the respective user terminal 12. The operation information is information instructing one of the items selectable with the tab 22 (more specifically, the type of performance value or the type of process setting value).

The acquisition section 140 of the server 14 acquires the operation information transmitted from the user terminal 12 by user operation. In response to the operation information of the user, the output section 144 of the server 14 changes the type of performance expressed in the performance data or changes the type of process setting value expressed in the process data, and changes the color of plot points expressing the principal component values according to the values expressed in the performance data or according to the values expressed in the process data. For example, as illustrated in FIG. 5, the output section 144 changes the color of the plot points according to the value expressed in the performance data or according to the value expressed in the process data. This thereby enables visualization of the relationship desired by the user between performance values or process setting values of a target object, and the principal component values of plural items of state data.

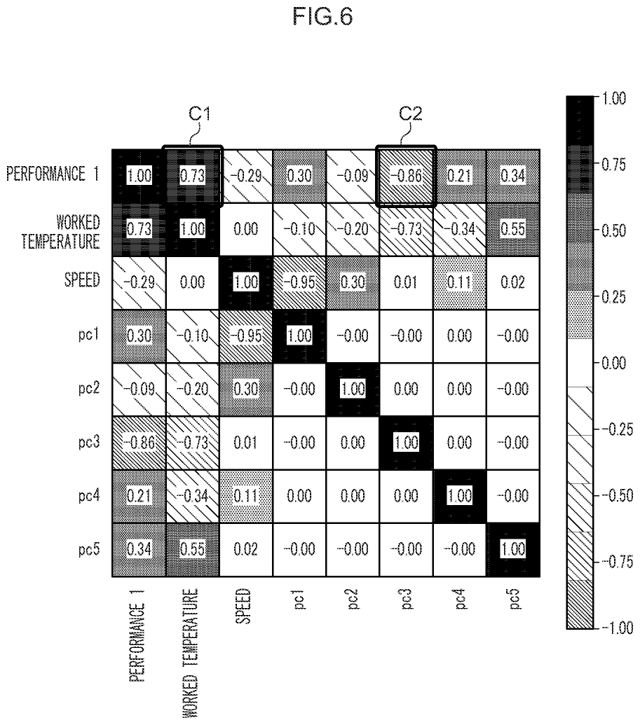

Note that the output section 144 may be configured so as to output information such as illustrated in FIG. 6 as the information expressing a relationship between principal component values of plural items of state data and performance data or process data. The information illustrated in FIG. 6 is a chart representing correlations between the principal component values (pc1 to pc5 are depicted in FIG. 6) of plural items of state data and the performance data or process data. Moreover, correlations between the performance data and the process data are also illustrated in FIG. 6.

In the example illustrated in FIG. 6, a correlation coefficient C1 between “performance 1” and “working temperature” is 0.73, indicating the possibility that the “working temperature” affects the “performance 1”. Moreover, in the example illustrated in FIG. 6, a correlation coefficient C2 between “performance 1” and “pc3” is −0.86, indicating the possibility that larger values of the “pc3” lead to smaller values of the “performance 1”. Moreover, from reference to FIG. 6 it is apparent that there is strong argument that an absolute value of the correlation coefficient C2 between the performance 1 and the principal component value pc3 is greater than an absolute value of the correlation coefficient C1 between the performance 1 and the working speed that is a process setting value.

Moreover, the output section 144 may be configured so as to identify unknown data representing different plot points to the plot point already present on the two-dimensional map and to transform the unknown data into state data.

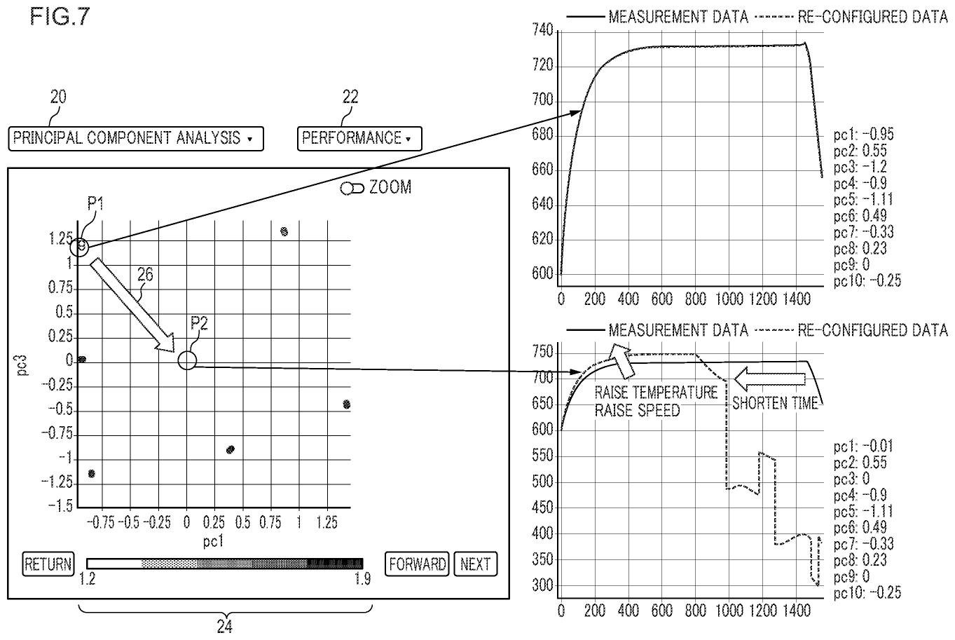

FIG. 7 is a diagram to explain transformation from unknown data to state data. As illustrated in FIG. 7, for example, in cases in which an operation 26 has been performed by the user so as to drag and drop from the plot point P1 to an unknown plot point P2, the output section 144 executes transformation processing from the unknown data representing the principal component values corresponding to the plot point P2 to the state data. Note that the state data corresponding to the plot point P1 is data actually measured when working the target object, and corresponds to “measurement data” illustrated in FIG. 7. However, the unknown state data corresponding to the plot point P2 is data that has not been measured when working the target object, and corresponds to “re-configured data” illustrated in FIG. 7. Note that there is a uniquely defined transformation from the principal component values corresponding to the unknown data to the state data that is re-configured data.

Thus, for example as illustrated in FIG. 7, the state data corresponding to the unknown data of the plot point P2 has a shorter time band of continuous high temperature than the state data of the plot point P1. It is accordingly apparent that the state data corresponding to the unknown data of the plot point P2 is data that results from reducing the time band of the state data of the plot point P1.

Moreover, as illustrated in FIG. 7, the state data corresponding to the unknown data of the plot point P2 has a higher maximum temperature than the state data of the plot point P1. More specifically, whereas the maximum temperature of the state data corresponding to the unknown data of the plot point P2 is 750°, the maximum temperature of the state data corresponding to the plot point P1 is 725°. It is accordingly apparent that the state data corresponding to the unknown data of the plot point P2 is data resulting from raising the temperature of the state data of the plot point P1.

Moreover, as illustrated in FIG. 7, the state data corresponding to the unknown data of the plot point P2 has a shorter time when a high temperature is achieved than the state data of the plot point P1. More specifically, when comparing a time needed for a temperature of the state data corresponding to the unknown data of the plot point P2 to reach 700° against a time needed for a temperature of the state data corresponding to the plot point P1 to reach 700°, then the state data of the plot point P2 is shorter. This means that it is apparent that the state data corresponding to the unknown data of the plot point P2 is data resulting from speeding up the state data of the plot point P1.

Thus in this manner the server 14 of the present exemplary embodiment transforms the unknown data corresponding to the plot point that is different to the already existing plot points on the two-dimensional map (more specifically, a plot point specified by the user as described above) into actual state data. Moreover, the server 14 outputs the transformed state data. This thereby enables state data to be generated that is unknown state data that has not been measured.

The user operates the user terminal 12 to check the information being displayed on the display section 122 of the user terminal 12. For example, a user references information such as that illustrated in FIG. 5 to FIG. 7, and checks the relationships between the state data and the performance or process setting values.

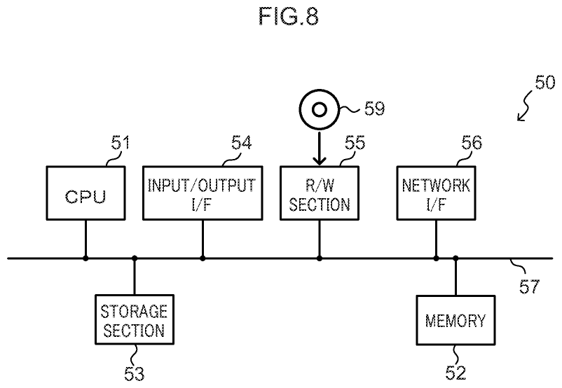

The user terminal 12 and the server 14 may, for example, be implemented by a computer 50 as illustrated in FIG. 8. The computer 50 implementing the user terminal 12 and the server 14 includes a CPU 51, a memory 52 serving as a transitory storage area, and a non-volatile storage section 53. The computer 50 includes an input/output interface (I/F) 54 connected to an input/output device or the like (omitted in the drawings), and a read/write (R/W) section 55 that controls reading of data from and writing of data to a recording medium 59. The computer 50 includes a network I/F 56 connected to a network such as the internet. The CPU 51, the memory 52, the storage section 53, the input/output I/F 54, the R/W section 55, and the network I/F 56 are connected together through a bus 57.

The storage section 53 may be implemented by a hard disk drive (HDD), solid state drive (SSD), flash memory, or the like. A program to cause a computer to function is stored in the storage section 53 serving as a storage medium. The CPU 51 reads the program from the storage section 53, expands the program in the memory 52, and sequentially executes the processes of the program.

Next, description follows regarding operation of the information processing system 10 of the exemplary embodiment.

A user inputs the respectively operated user terminal 12 with a data set combining the state data, the performance data, and the process data for each of plural target objects.

The control section 120 of the user terminal 12 receives a data set according to operation by the user. The control section 120 transmits the data set to the server 14 according to operation by the user.

When the data set has been transmitted from the user terminal 12 to the server 14, the acquisition section 140 of the server 14 acquires the data set transmitted from the user terminal 12. The acquisition section 140 stores the data set in the data storage section 141.

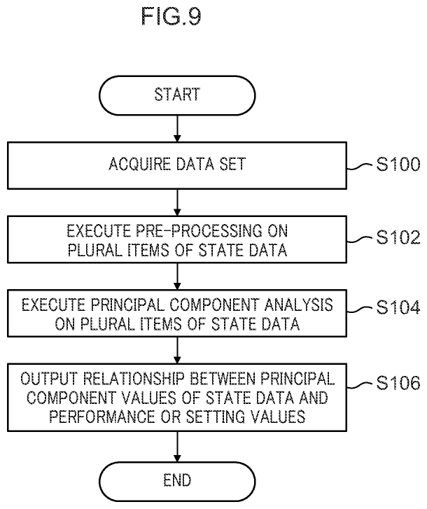

The server 14 executes an information processing routine illustrated in FIG. 9 when a specific instruction signal transmitted from the user terminal 12 has been received.

At step S100, the analysis section 142 of the server 14 acquires the data set by reading the data set from the data storage section 141.

At step S102, the analysis section 142 of the server 14 executes pre-processing such as described above on the plural items of state data in the data set.

At step S104, the analysis section 142 of the server 14 generates principal component values for the plural items of state data by executing principal component analysis on the plural items of state data resulting from executing the pre-processing of step S102.

At step S106, the output section 144 of the server 14 outputs the two-dimensional map that is information representing relationships between the principal component values of the plural items of state data generated at step S104 and the performance values expressed in the performance data or the process setting values expressed in the process data. Note that color is added to the plot points on the two-dimensional map according to the performance values or the process setting values of the target objects.

The user operating the user terminal 12 checks the two-dimensional map output from the server 14, and checks the relationships between the principal component values of plural items of state data and the performance values expressed in the performance data or the process setting values expressed in the process data. The user operating the respective user terminal 12 operates the tab 22 illustrated in FIG. 5 and FIG. 7 so as to select the type of performance value of the target object or the type of process setting value. This thereby enables a visualization of the relationship desired by the user between the performance value of the target object or the process setting values and the principal component values of the plural items of state data.

As described above, the server of the information processing system according to the exemplary embodiment acquires the data set including combinations of state data representing time series of states when the target object is worked, and at least one of performance data representing performance of the target object or process data representing process setting values when the target object is worked. The server generates the principal component values of plural items of state data by executing principal component analysis on the plural items of state data in the acquired data set. The server outputs information representing a relationship between principal component values of plural items of state data and at least one of the performance data or process data. Information can accordingly be acquired representing the relationship between the time series data of the state when the target object is worked and the performance of the target object or the process setting values when the target object is worked. Moreover, the user is able to ascertain what sort of data the state data is when the target object having the performance value desired by the user is worked.

Moreover, the computational load is often high when time series data is used as is when executing specific computational processing on the time series data such as the temperature profiles disclosed in JP-A No. 2021-025110.

In contrast thereto, the server of the information processing system according to the exemplary embodiment generates the principal component values of plural items of state data by executing principal component analysis on the plural items of state data. The data volume of the state data that is the time series data is able to be reduced by utilizing these principal component values in the computational processing, and so this enables the computational load of the specific computational processing to be reduced. For example, when executing specific processing using a machine learning model, the load for training processing and computational processing of the machine learning model can be reduced by using the principal component values of the time series data as the input data to the machine learning model.

Moreover, although description has been given of a case in which the processing performed by the computer 50 of each of the exemplary embodiments described above is software processing performed by executing a program, there is no limitation thereto. For example, the processing may be performed by hardware, such as a graphics processing unit (GPU), an application specific integrated circuit (ASIC), an field programmable gate array (FPGA), or the like. Alternatively, the processing may be performed by a combination of both software and hardware. Moreover, in cases in which software processing is employed, a program may be distributed stored on various storage media.

Furthermore, the present disclosure is not limited to the above, and obviously various other modifications may be implemented within a scope not departing from the spirit of the present disclosure.

For example, the state data of the above exemplary embodiment may be any data as long as it is data representing a time series of states when the target object is worked. Moreover, the performance data may be any data as long as it is data representing a performance of the target object. Moreover, the process data may be any data as long as it is data representing a process setting value when the target object is worked.

Moreover, the server 14 may be configured so as to output information representing a regression equation between the performance data or process data and the principal component values as the information representing a relationship between the principal component values of plural items of state data and the performance values expressed in the performance data and the process setting values expressed in the process data. In such cases, for example, the performance value of the target object may be set as a response variable of the regression equation, and the process setting values and the principal component values may be set as explanatory variables of the regression equation. This thereby enables a regression equation to be obtained between the performance values of the target object and the principal component values that are the results of principal component analysis.

Moreover, although in the above exemplary embodiment an example was described of a case utilizing the performance data representing the performance of the target object and the process data representing the process setting values when the target object is worked, there is no limitation thereto. For example, one data may be utilized alone from out of the performance data representing the performance of the target object or the process data representing the process setting values when the target object is worked.

Moreover, for example, instead of performance data representing the performance of the target object, data representing a structure or physical property of a material that is the target object may be employed. For example, data representing the structure or physical property of a material includes data representing a bonding state, mass, crystal structure, or the like of a material as measured by various analysis techniques (for example, infrared (IR) spectroscopy, mass spectrometry (MS), or X-ray diffraction (XRD)). Alternatively, the data representing the structure or physical property of the material may be data representing an index obtained by quantification of a material structure equation (for example as in extended-connectivity fingerprints (ECFP) or simplified molecular input LINE entry system (SMILES)). The data representing the structure or physical property of the material may, for example, be transformed into numerical data so as to make clear the relationships between the principal component values of plural items of state data. In cases in which data representing the structure or physical property of a material is employed, for example, as the information expressing relationships between the principal component values of plural items of state data and the data representing the structure or physical property of the target object, the server 14 may output data representing a two-dimensional map as described above, and information representing correlations or information representing regression equations. This thereby enables information expressing relationships between the time series data of states when the target object is worked and the structure or physical property of the target object to be acquired. Moreover, in the above data set, the state data of the target object may be combined with at least one out of the performance data of the target object, data representing the structure or physical property of the target object, or the process data of the target object. In such cases, the server 14 outputs information expressing a relationship between the state data of the target object, and at least one out of the performance data of the target object, state data representing the structure or physical property of the target object, or the process data of the target object.

All publications, patent applications, and technical standards mentioned in this specification are herein incorporated by reference to the same extent as if each individual publication, patent application, or technical standard was specifically and individually indicated to be incorporated by reference.

What is claimed is:

1. An information processing device comprising a memory, and a processor coupled to the memory, wherein the processor is configured to:
acquire a data set including a combination of state data representing a time series of states when a target object is worked combined with at least one of performance data representing a performance of the target object, data representing a structure or physical property of the target object, or process data representing a process setting value when the target object is worked;
generate a principal component value of each of a plurality of items of the state data in the acquired data set by executing principal component analysis on the plurality of items of state data; and
output information representing a relationship between principal component values of the plurality of items of state data, and the at least one of the performance data, the data representing the structure or physical property, or the process data.

2. The information processing device of claim 1, wherein the processor is configured to:
output data representing a two-dimensional map including plot points of the principal component values of the state data as the information representing the relationship; and
change a color of the plot points representing the principal component values according to at least one of a value expressed in the performance data, a value expressed in the data representing the structure or physical property, or a value expressed in the process data.

3. The information processing device of claim 1, wherein the processor is configured to output, as the information representing the relationship, information representing a correlation between the principal component values and at least one of a value expressed in the performance data, a value expressed in the data representing the structure or physical property, or a value expressed in the process data.

4. The information processing device of claim 1, wherein the processor is configured to output, as the information representing the relationship, information representing a regression equation between the principal component values and at least one of a value expressed in the performance data, a value expressed in the data representing the structure or physical property, or a value expressed in the process data.

5. The information processing device of claim 2, wherein the processor is configured to identify unknown data representing a plot point different from already existing plot points on the two-dimensional map, and to transform the unknown data into the state data.

6. An information processing method comprising, by a processor:
acquiring a data set including a combination of state data representing a time series of states when a target object is worked combined with at least one of performance data representing a performance of the target object, data representing a structure or physical property of the target object, or process data representing a process setting value when the target object is worked;
generating a principal component value of each of a plurality of items of the state data in the acquired data set by executing principal component analysis on the plurality of items of state data; and
outputting information representing a relationship between principal component values of the plurality of items of state data, and the at least one of the performance data, the data representing the structure or physical property, or the process data.

7. A non-transitory recording medium storing an information processing program executable by a processor to:
acquire a data set including a combination of state data representing a time series of states when a target object is worked combined with at least one of performance data representing a performance of the target object, data representing a structure or physical property of the target object, or process data representing a process setting value when the target object is worked;
generate a principal component value of each of a plurality of items of the state data in the acquired data set by executing principal component analysis on the plurality of items of state data; and
output information representing a relationship between principal component values of the plurality of items of state data, and the at least one of the performance data, the data representing the structure or physical property, or the process data.
